(19) United States
(12) Patent Application Publication
(10) Pub. No.: US 2022/0386586 A1
(43) Pub. Date: Dec. 8, 2022

(54) INSECT ZAPPER DEVICE

(71) Applicant: MAKE GREAT SALES LIMITED, Wan Chai (HK)

(72) Inventors: Bruce Peter Cran, Ho Chi Minh City (VN); Kin Choi Lee, Wanchai (HK)

(21) Appl. No.: 17/351,378

(22) Filed: Jun. 18, 2021

Related U.S. Application Data
(63) Continuation-in-part of application No. 29/786,710, filed on Jun. 2, 2021.

(51) Int. Cl. A01M 1/22; A01M 1/04

(52) U.S. Cl. CPC A01M 1/223; A01M 1/04

(57) ABSTRACT

An insect zapper device comprises a zapper element and a cleaning element. The zapper element comprises a base portion, a plastic housing on the base portion, electric coils on the plastic housing, and a power source to deliver energy to the electric coils. The cleaning element has a plurality of brushes and is slidable with respect to the zapper element to transport the plurality of brushes along the electric coils to dislodge dead insects.

### CROSS REFERENCE TO RELATED APPLICATIONS

This application claims benefit of U.S. Design Application No. 29/786,710, filed Jun. 2, 2021, and entitled BUG ZAPPER, which is hereby incorporated by reference in its entirety.

### FIELD OF INTEREST

The present inventive concepts relate to an insecticidal device and, more particularly, to an insect zapper with cleaning capabilities.

### BACKGROUND

Biting insects, such as mosquitoes and flies, can be an annoying, serious problem. Beyond mere annoyance, such insets can carry and transmit life-threatening virus. People have tried a number of different methods to rid themselves of mosquitoes and other biting insects.

One approach to combat mosquitoes is to use a bug “zapper.” In general, a bug zapper includes a fluorescent light source surrounded by an electrified grid. The theory behind these devices is that the mosquitoes are attracted to the light and, upon flying to the light, will be electrocuted by the grid.

Some devices may include, for example, a source of carbon dioxide, a source of octenol (an alcohol that is given off by mammalian blood hosts), and/or a heat source as lures that draw mosquitos into the device. When the bug zapper is operating, it produces the required heat and convective air flow to vaporize the attractant, e.g., the octenol, and dispense it at the proper rate.

In an apparatus having both the bug zapper and the octenol lure, the apparatus generally includes a source of carbon dioxide, a source of octenol, a device for emitting the carbon dioxide proximate the source of octenol to create a mixture of the carbon dioxide and octenol, a heating element, and an electrified grid. Insects are initially attracted to the apparatus by the odor associated with the mixture of carbon dioxide and octenol. As the insects fly closer to the apparatus, they are further attracted to the visual properties of the apparatus and then, at close range, they are attracted to the heat emitted by the heating element. In an attempt to fly closer to the heating element, the insects are intercepted by the electrified grid and destroyed. A disadvantage of such a device is that the insects become trapped in the device and the electric grid is difficult to clean. Ultimately, this can cause degradation in the operation of the device, making it less effective.

There exists a need for a mosquito attractor and trap, or insect zapper, that is easily cleaned such that insects can be easily removed from the device.

Thus, it would be advantageous to have a mechanism for cleaning the mosquito attractor and trap, such as the electric coils that form the zapping grid. It would be advantageous for the insect zapper to include a cleaning mechanism that is integral and elegant.

### SUMMARY

In accordance with the inventive concepts, provided is an insect zapper device, comprising a zapper element comprising and a cleaning element. The zapper element includes a base portion; an inner housing on the base portion; electric coils on the plastic housing; and a power source to deliver energy to the electric coils. The cleaning element has a plurality of brushes, the cleaning element being movable with respect to the zapper element to transport the plurality of brushes along the electric coils to dislodge dead insects.

In various embodiments, the device further comprises an outer housing having slats spaced apart from each other surrounding the inner housing and electric coils.

In various embodiments, the plurality of brushes extends through the slits of the outer housing to engage the electric coils.

In various embodiments, the base portion comprises a compartment for an octenol lure and is constructed and arranged to dispense the octenol lure.

In various embodiments, the inner housing comprises openings along a bottom portion, the openings constructed and arranged to allow convective air flow to vaporize the octenol lure and dispense the octenol lure.

In various embodiments, the device further comprises at least one visual lure on the base portion surrounded by the inner housing.

In various embodiments, the at least one visual lure comprises a plurality of purple LEDs that illuminate the inner housing.

In various embodiments, the cleaning element comprises openings exposing the insect zapper element.

In various embodiments, the device further comprises ridges on the inner housing extending crosswise to a sliding direction of the cleaning element.

In various embodiments, the ridges comprise protrusions, the electric coils being wrapped around the protrusions.

In various embodiments, the device further comprises an outer housing having slats spaced apart from each other surrounding the plastic housing and electric coils, wherein the slats are positioned in recesses between the protrusions.

In various embodiments, the cleaning element comprises a removable strap.

In various embodiments, the removable strap may be coupled to the cleaning element in a plurality of configurations.

In various embodiments, the base portion comprises non-slip feet.

In various embodiments, the inner housing comprises light guide transparent plastic.

In various embodiments, the power source is at least one rechargeable battery and the base portion comprises a USB Type-C charging port.

In various embodiments, the base portion comprises a release button that disengages a lock and releasing the cleaning element to enable the movement with respect to the zapper element.

In various embodiments, the cleaning element is configured to slide with respect to the zapper element.

In various embodiments, the base portion comprises at least one control button constructed and arranged to change an operating mode of the device among a plurality of different operating modes.

In various embodiments, the control button changes the operating mode of the device between a first operating mode in which the device is not operating, a second operating mode in which the device is operating with both the electric coils and a visual lure in operation, and a third mode in which the device is operating with only the electric coils in operation.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. Below is a brief description of the drawings.

FIG. 1 is a perspective view of a cleaning element of an insect zapper, in accordance with aspects of inventive concepts.

FIG. 2 is a perspective view of an insect attraction and destruction element of an insect zapper, in accordance with aspects of inventive concepts.

FIG. 3 is a perspective view of a portion of the insect attraction and destruction element of the insect zapper of FIG. 2, in accordance with aspects of inventive concepts.

FIG. 4 is a perspective view of a portion of the insect attraction and destruction element of the insect zapper of FIG. 2, in accordance with aspects of inventive concepts.

FIG. 5 is front view of a portion of the insect attraction and destruction element of FIG. 2, in accordance with aspects of inventive concepts.

FIG. 6 is an exploded bottom perspective view of the insect zapper in a closed configuration, in accordance with aspects of inventive concepts.

FIG. 7 is a perspective view of the insect zapper in a partially opened configuration, in accordance with aspects of inventive concepts.

FIG. 8 is a perspective view of the insect zapper in the closed configuration, in accordance with aspects of inventive concepts.

FIG. 9 is a perspective front view of the insect zapper of FIG. 7 in a closed configuration of with a strap in an alternative configuration, in accordance with aspects of inventive concepts.

FIG. 10 is a rear view of the insect zapper of FIG. 7, in accordance with aspects of inventive concepts.

### DETAILED DESCRIPTION OF EXEMPLARY EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

In accordance with the inventive concepts, there is provided an insect zapper apparatus having an insect attraction and destruction element (or zapper element) and a cleaning element. The insect attraction element operates to attract and destroy insects, while the cleaning element is useful for cleaning the dead bugs from the zapper element.

The zapper element includes an electrical element and at least one bug lure. The at least one bug lure can include, as examples, an octenol lure and/or one or more lights. In various embodiments, the zapper element includes a source of octenol, an octenol dispensing mechanism, electric coils, and a visual lure, e.g., at least one light source. In operation, insects are initially attracted to the apparatus by the odor associated with the dispensed octenol. As the insects fly closer to the apparatus, they are further attracted to the visual lure. In an attempt to fly closer to the visual lure, the insects fly into the apparatus, are intercepted by the electric coils, and are destroyed using electrical charge generated by the electrical coils.

The cleaning element can be a mechanical cleaning element, e.g., that uses abrasion to clean portions of the zapper element. In various embodiments, the cleaning element is a movable cleaning mechanism that is configured to removably couple to the zapper element. In various embodiments, the cleaning element has a plurality of brushes, wherein the brushes are slidable along the electric coils to clean the electric coils and remove the dead insects from the apparatus using abrasion.

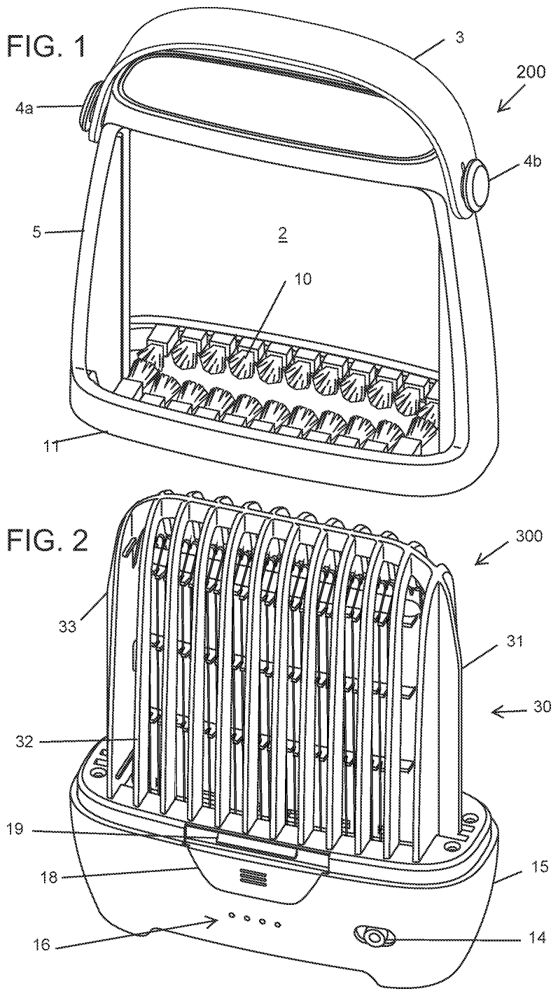

FIGS. 1 through 10 variously show an embodiment of an insect zapper 100, or portions thereof, in accordance with aspects of the inventive concepts. As is shown in the various views, the insect zapper 100 includes a cleaning element 200, shown in FIG. 1, and an insect attraction and destruction element 300 (also referred to as a zapper element 300), shown in FIG. 2.

Referring to FIG. 1, the cleaning element 200 is detachable and removable from the zapper element 300. The cleaning element includes a frame 5 that provides the overall structure of the element.

At a top end of the frame 5, the cleaning element 200 can comprise a removable and/or reconfigurable handle 3. The handle can comprise a strap 3 that can attach to one or more buttons 4. In this embodiment, the buttons 4 are positioned on opposite first and second sides of the top end of the frame 5. The strap 3 comprises openings, e.g., slits or holes, configured to receive the buttons 4 so that the strap 3 can be removably attached to the cleaning element 200 and used as a handle for carrying the insect zapper apparatus 100. The strap/handle 3 can also be used for separating the cleaning element 200 from the zapper element 300.

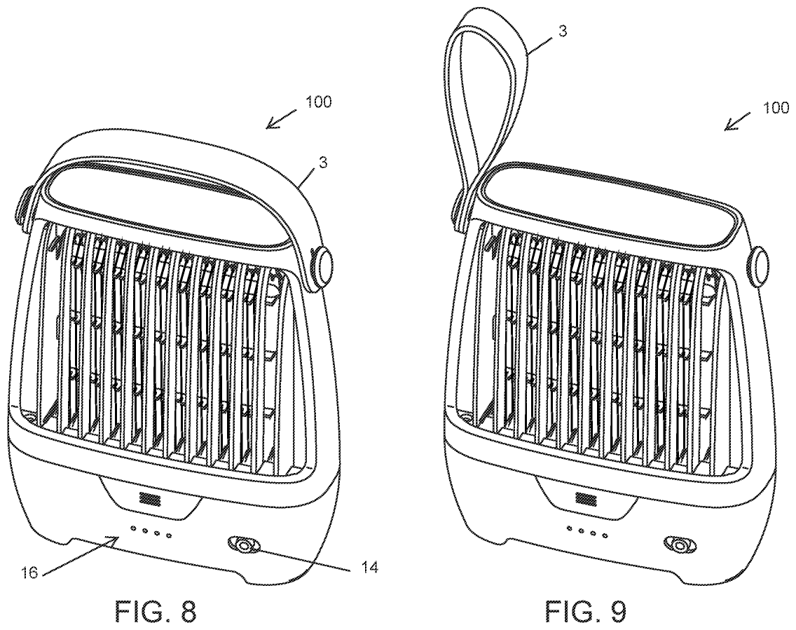

In preferred embodiments, the removable strap 3 can be coupled to one or more of the buttons 4a,b to take different carrying configurations, forming different types of handles. As seen in FIGS. 1 and 8, as well as other figures, the strap 3 can be configured with a first end coupled to a first button 4a and a second end coupled to a second button 4b to form the handle attached to the cleaning element 200. In another example, as seen in FIG. 9, both ends of the strap 3 can be coupled to one button, e.g., button 4a, such that the insect zapper 100 can be placed on a hook or over a closed pole or the strap can be used as a wrist strap.

The handle/strap 3 can comprise or be made of a flexible material, for example, polyurethane (PU), rubber, plastic, and/or silicone. In alternative embodiments, the handle/strap 3 can additionally or alternatively comprise one or more different materials, so long as such materials are flexible and provide sufficient structural integrity to hold the weight of the insect zapper apparatus 100.

In various embodiments, the frame 5 of the cleaning element 200 can comprise or can be formed from acrylonitrile butadiene styrene (ABS), polycarbonate (PC), or combinations thereof. In alternative embodiments, the cleaning element additionally or alternatively comprise one or more different materials.

Referring to FIG. 2, the zapper element 300 includes an outer housing 30 that surrounds an inner housing 40 to which is mounted at least one electric coil 20. The outer housing 30 provides protection from the electric coils 20 wound around the inner housing 40. The outer housing 30 includes slats 32 through which the insects may pass to the electric coils 20. The spacing between the slats 32 of the outer housing 30 can be rigid and fixed or limited flexibility to prevent accidental touching of the electric coils 20. For example, the distance between the slats 32 of the outer housing 30 can be 5 to 8 mm, or preferably about 6.52 mm, such that bugs can fly through, but fingers cannot easily go through the slats 32 and touch the electric coils 20.

In some embodiments, the outer housing 30 can comprise or be formed from acrylonitrile butadiene styrene (ABS), polycarbonate (PC), or combinations thereof. In alternative embodiments, outer housing 30 additionally or alternatively can comprise one or more different materials. The outer housing 30, therefore, provides a protective element surrounding the lures and electrical insect destroying elements (e.g., coils 20) of the zapper element 300.

In preferred embodiments, the cleaning element 200 has a sliding relationship with the zapper element 300. To accommodate the sliding relationship, the outer housing 30 includes at least one outwardly extending rail, e.g., rails 31,33. The cleaning element 200 includes at least one corresponding internal channel or rail guide (not shown) configured to slidingly receive the rails 31,33. In other embodiments, different forms of cooperative sliding mechanisms and structures could be embodied in the cleaning element 200 and the zapper element 300 to effect the sliding relationship between the two elements.

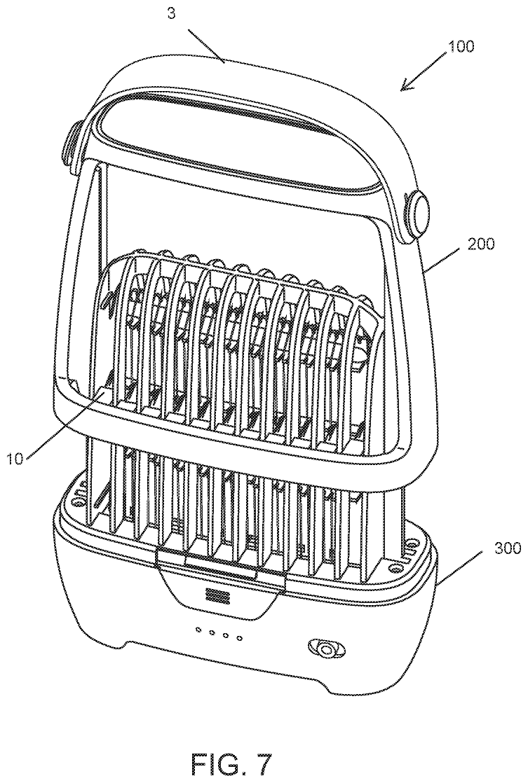

As seen in FIGS. 1 and 7, the cleaning element 200 of the insect zapper 100 can comprise at least one cleaning brush 10 for easy cleaning of the electric coils 20 and/or other portions of the zapper element 300. The cleaning element 200 defines at least one window or opening 2 exposing the outer housing 30 of the insect zapper element 300 when the cleaning element 200 is mounted on the zapper element, as is shown in FIGS. 8-10. In the depicted embodiment, the cleaning element 200 defines front and rear openings or windows 2 that provide access to the zapper element 300 from front and rear sides of the insect zapper 100.

In various embodiments, the frame 5 of the cleaning element 200 includes at least one cleaning device 10, extending inwardly toward a center of the cleaning element 200. In the depicted embodiments, the at least one cleaning device 10 includes a plurality of brushes 10 disposed at a bottom end of the frame 5. More particularly, the bottom end of the frame 5 forms an opening configured to receive the zapper element 300. The brushes 10 are coupled to an internal portion of the bottom end opening and are arranged such that bristles from the brushes 10 are directed inwardly. As such, the brushes 10 inscribe a majority of the bottom end opening sufficient to clean dead bugs from all or substantially all portions of the zapper element 300 by sliding the cleaning element 200 up and down with respect to the zapper element 300, see also FIG. 7.

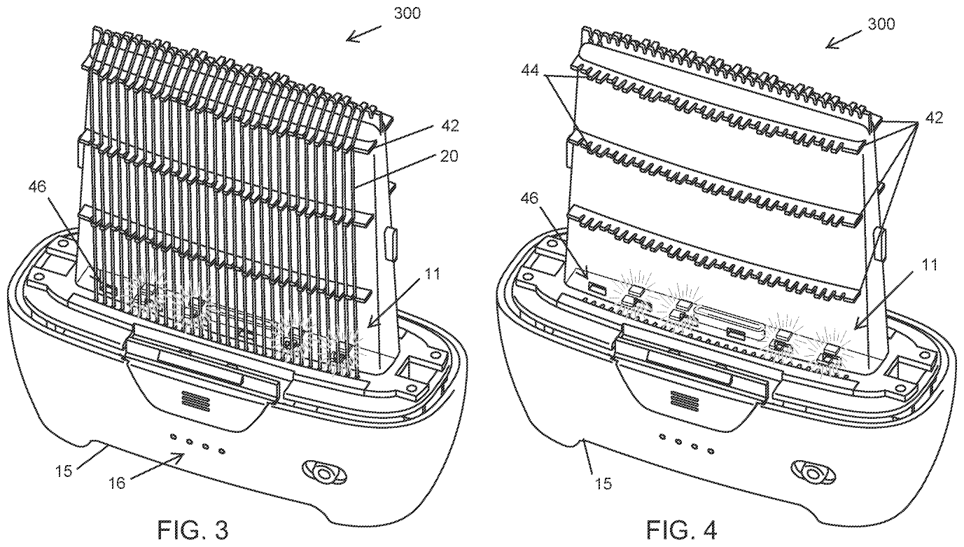

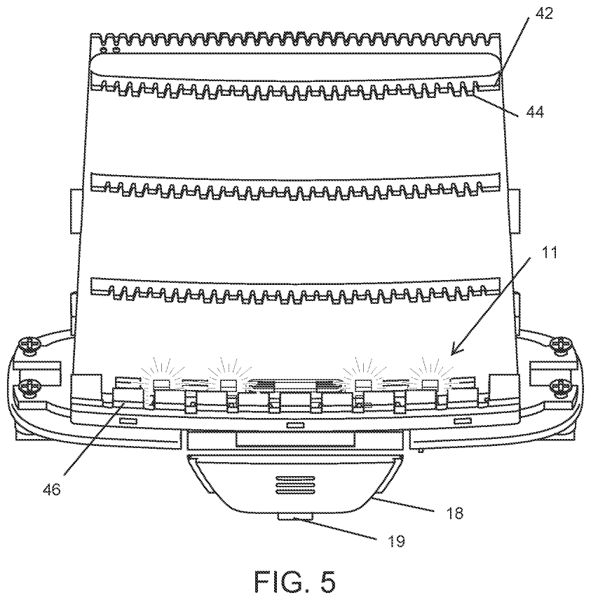

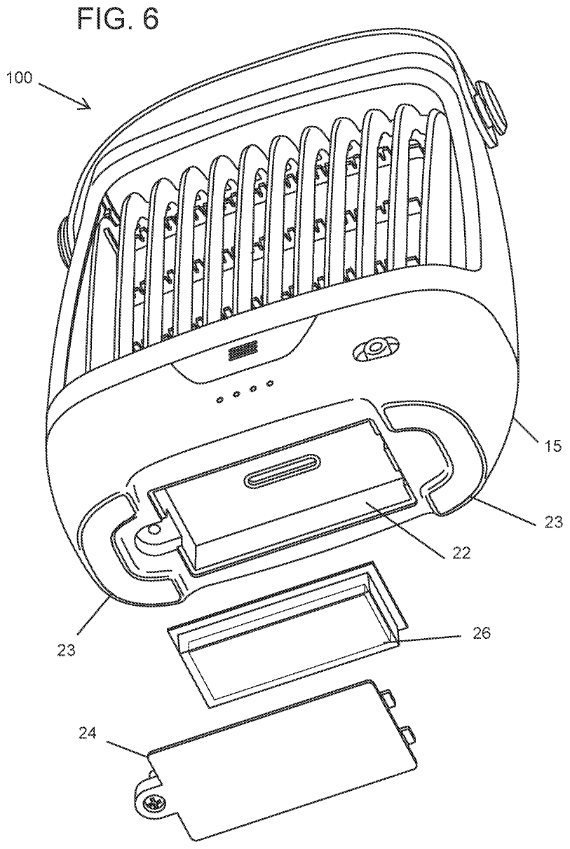

FIG. 3 is a perspective view of a portion of the zapper element 300 with the outer housing 30 removed. FIG. 4 is a perspective view of a portion of the zapper element 300 of the FIG. 3 with the coils 20 removed, more clearly revealing the inner housing 40. FIG. 5 is a front view of the inner housing 40 with a base portion 15 removed.

As seen in FIGS. 3 through 5, the inner housing 40 has a plurality of rows 42 of protrusions 44 that extend outwardly. In this embodiment, the rows 42 of protrusions 44 are perpendicular or crosswise to the sliding direction of the cleaning element 200. The rows 42 of protrusions 44 are formed on the front and back sides of the inner housing 40. To form one or more electric coils 20, one or more electric wires are wound through and around the protrusions 44, in a vertical direction in the depicted embodiment. In various embodiments, the electric wires are unshielded copper wires. Charge from the coils kills insects that fly into the insect zapper 100.

The plastic housing 40 allows for the insects killed by the electric coils 20 to be more easily cleaned from the electric coils 20 and prevents the insects from being trapped in between the electric coils 20. The plastic housing 40 preferably prevents the insects from falling into a portion between the electric coils 20. The plastic housing 40 allows for the insect bodies on one side to be cleaned and fall out on the same side when the side is facing downward.

In various embodiments, the insect zapper 100 includes at least one visual lure, for example, purple LEDs 11, which lure the insects. In some embodiments, the purple LEDs 11 are provided inside the plastic housing 40. In the embodiments shown, for example, the insect zapper 100 includes eight purple LED lures. Other types of visual lures may be used. The visual lure for attracting insects can be, for example, UV-A LED (315-400 nm) or visible violet LED (380-450 nm). The visual lures are provided in the base portion 15. In some embodiments, the base portion may additionally include a thermal lure for attracting insects.

As seen in FIGS. 3 and 4, the internal housing 40 is provided on and couples to the base portion 15, which holds electronics and power sources of the insect zapper 100. The inner housing 40 can be transparent or semitransparent and surround one or more light sources, e.g., LEDs 11, to create a visual lure. As an example, inner housing 40 can be formed from or comprise transparent plastic. The inner housing 40 allows light from the visual lure, i.e., LEDs 11, to pass through the plastic housing 40. Light from the LEDs 11 can cause the inner housing 40 to glow to attract insects. In various embodiments, the inner housing 40 can comprise or be formed from light guide transparent plastic, for example, Polycarbonate, PMMA (Acrylic), Polyethylene Terephthalate (PET), Amorphous Copolyester (PETG), or the like, or a combination thereof.

Referring to FIG. 5, the inner housing 40 and/or base portion 15 can include at least one release button 18 that unlocks the cleaning element 200 from the zapper element 300. As seen in FIGS. 1 and 6, the plurality of brushes 10 along the bottom portion of the cleaning element 200 extend through and between the plurality of slats 32 of the outer housing 30. When the release button 18 is pushed, the cleaning element 200 is disengaged from the zapper element 300 and pulled up by a user, wherein the plurality of brushes 10 of the cleaning element 200 slide along the electric coils 20 cleaning the insects therefrom. In some embodiments, the zapper element 300 is automatically lifted by mechanisms including spring-loaded or motor driven.

The base portion 15 can comprise or be formed of a hard plastic. For example, the base portion can comprise or be formed from acrylonitrile butadiene styrene (ABS), polycarbonate (PC), or a combination thereof. In alternative embodiments, the base portion additionally or alternatively can comprise one or more different materials.

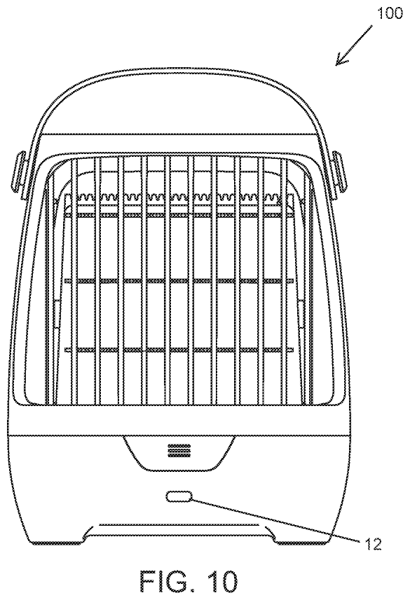

The base portion 15 of the zapper element 300 can also include a charging port 12 (see FIG. 10), at least one control button 14, and at least one status indicator 16.

In some embodiments, a control button 14 is configured to control the functional elements of the insect zapper 100. As examples, the control button 14 can be configured to turn ON and OFF the dispensing of the octenol lure 26, the electric coils 20, and/or purple LEDS 11 of the insect zapper 100. In some embodiments, the LEDs 11 of the insect zapper 100 can be other colors like blue or yellow, as examples.

The insect zapper 100 can include includes a plurality of zap modes, for example, a mode in which electric coils 20 and purple LEDs 11 (visual lure) operate and a mode when only the electric coils 20 are operating. The control button 14 can be used to control and transition between operational modes of the insect zapper 100. For example, via the control button 14, in a first mode, the user may turn ON/OFF all the elements of the insect zapper 100. In a second mode, via the control button 14, the user may turn ON/OFF the elements of insect zapper 100 except for the purple LEDs 11. In a third mode, via the control button 14 all the elements of the insect zapper 100 may be turned OFF.

In the embodiment shown, the zapper element 300 comprises one control button 14. In alternative embodiments, the zapper element 300 can comprise a different number of control buttons 14. In some embodiments, the control button 14 can comprise or be formed from acrylonitrile butadiene styrene (ABS), polycarbonate (PC), or combinations thereof. In alternative embodiments, the control button 14 can additionally or alternatively comprise or be formed of one or more different materials.

The one or more status indicators 16 of the zapper element (or base portion 15 thereof) can be configured to display a signal corresponding whether the battery is fully charged and/or whether the self-cleaning insect zapper 100 is ON. At least one of the status indicators 16 may be configured to blink until the batteries are fully charged. When the insect zapper 100 is fully charged, the at least one status indicators 16 can become and remain solid. The status indicators 16 can also be used to indicate an operational mode of the insect zapper 100, with different modes indicated by different colors and/or patterns of the status indicators. For example, the status indicators 16 may take the form of or include one or more light-emitting diodes (LEDs).

Referring to FIG. 7, the cleaning element 200 and the zapper element 300 removably couple together. The coupling between the cleaning element and the zapper element can take the form of any of a number of known removable couplings, including, but not limited to, magnets, hooks, buttons, compression fit, snap fit, a sliding mechanism, or any such suitable coupling mechanism, or combinations thereof, that create a removable coupling between the cleaning element 200 and the zapper element. In some embodiments, the cleaning element 200 is not necessarily completely removed or removable from the zapper element 300, but the cleaning element 200 can slide up and down in a controlled, limited distance with respect to the zapper element 300 sufficient to transport the plurality of brushes to dislodge dead insects.

In various embodiments, the bottom end of the cleaning element 200 can couple to a rim 17 of the base portion 15 of the zapper element 300, e.g., see FIGS. 2 and 7. The base portion can include a lock 19 that locks the cleaning element to the base portion 15 of the zapper element 300. In some embodiments, the release button 18 of the base portion 15 is constructed and arranged to disengage the lock 19 and release the cleaning element 200 from the base portion 15 (and zapper element 300), enabling the cleaning element 200 to slide relative to the outer housing 30 of the zapper element.

In some embodiments, such as the one shown in FIG. 5, the base portion 15 of the insect zapper 100 comprises a printed circuit board (PCB) (not shown). In some embodiments, the PCB includes various functional circuit components that allow for electrical coordination of power and control functions of the insect zapper 100, and provides interconnections between various electrical functional and control elements.

Referring to FIG. 6, the base portion 15 may additionally include a compartment 22 for inserting the octenol mosquito lure 26 and a removable compartment cover 24. In some embodiments, the base portion 15 can include non-slip feet 23 on a bottom portion thereof for a better grip on flat surfaces. In some embodiments, the non-slip feet 23 can be formed of rubber and/or silicone. In alternative embodiments, the non-slip feet 23 can be formed of and/or comprises different materials.

In some embodiments, the zapper element 300 comprises one or more rechargeable batteries and a charging port 12, as seen in FIG. 10. In some embodiments, the base portion 15 of the zapper element includes at least one battery having a long battery life, for example, at least one batter having a capacity of 4000 mAh. The one or more batteries may provide energy to the different components of the apparatus, including, but not limited to, the dispensing of the octenol lure, electric coils 20, the LEDs 11, the heating elements, and/or status indicators 16. In some embodiments, the one or more batteries can be rechargeable. In alternative embodiments, other types of rechargeable batteries could be used, including a solar battery. In some embodiments, the one or more battery could include a replaceable battery, such as a non-rechargeable battery, such as disk batteries.

In some embodiments, the charging port can be a USB Type-C charging port 12 located in the base portion 15 and configured to allow for charging the one or more rechargeable batteries. In alternative embodiments, the zapper element 300 can comprise a different type of charging port. In alternative embodiments, the charging port can be located at a different location. In some embodiments, the charging port can comprise a protective cover. In some embodiments, the protective cover comprises silicone. Preferably, in at least some embodiments, the charging port 12 remains accessible while the device 100 is in use. In still other embodiments, the insect zapper 100 can be configured for wirelessly charging.

Referring to FIG. 7, when the cleaning element 200 slides, the plurality of brushes 10 of the cleaning element 200 run up and down the coils 20 to clean the insects trapped thereon and on the plastic housing 40. The rows of ridges 42 with protrusions 44 provide further friction or turbulence between the plastic housing 40 and the plurality of brushes 10 so that the insect bodies can be more easily dislodged from the plastic housing 40, coils 20, and the plurality of brushes 10. In some embodiments, recesses are provided between the protrusions 44 of the ridges 42. Some of the recesses and protrusions are constructed and arranged to hold the electric coils 20 in place, wherein electrical wire can be wrapped around and between the protrusions to form the coils 20. In addition, some recesses between the protrusions 44 are constructed and arranged to hold the slats 32 of the outer housing 30 in place, so that the separation between the slats 32 is fixed to prevent accidental touching. In one example embodiment, the brushes of the cleaning element 200 include, but not limited to sponge, foam, and rubbery material, and the form of the brushes include but not limited to, pads, tips, bristles, sponges, and ball tip pins.

Openings 46 on the plastic housing 40 are provided on two sides of the plastic housing 40. The openings 46 are constructed and arranged to allow convective air flow to vaporize the octenol mosquito lure and dispense it. The openings 46 are provided at a bottom of the plastic housing 40 so that the insect bodies are prevented from falling into the plastic housing 40 when one is sliding the cleaning element 200 to clean the electric coils 20.

In some operations, when a user is cleaning the electric zapper coils 20 with the cleaning element 200, one side of the device faces downward for cleaning, i.e., so that the insect bodies fall from it, then the device is flipped so that opposite side of the device faces downward for cleaning. In some embodiments, the sliding action of the cleaning element 200 is a single sliding action to remove all of the insect bodies on one side. In an alternative embodiment, the cleaning element 200 is slid back and forth along the electric coils 20.

In various embodiments, the insect zapper has a greater width than depth. In some embodiments, the insect zapper 100 is about 125 mm wide, 52 mm deep, and about 40 mm high (exclusive of the handle 3). The insect zapper 100 can have a substantially narrow profile so that it is easier to store compared to a cylindrical design, for example.

In some embodiments, the insect zapper 100 includes a kill area of, for example, about 169.28 cm², considering openings in the front and rear. In other embodiments, the kill area can be greater or less.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provided in combination in a single embodiment. Conversely, various features of the invention which are, for brevity, described in the context of a single embodiment may also be provided separately or in any suitable sub-combination. For example, it will be appreciated that all of the features set out in any of the claims (whether independent or dependent) can combined in any given way.

What is claimed is:

1. An insect zapper device, comprising:
a zapper element comprising:
a base portion;
an inner housing on the base portion;
electric coils on the inner housing; and
a power source to deliver energy to the electric coils; and
a cleaning element having a plurality of brushes, the cleaning element movable with respect to the zapper element to transport the plurality of brushes along the electric coils to dislodge dead insects.

2. The device of claim 1, further comprising an outer housing having slats spaced apart from each other surrounding the inner housing and electric coils.

3. The device of claim 2, wherein the plurality of brushes extends through the slats of the outer housing to engage the electric coils.

4. The device of claim 1, wherein the base portion comprises a compartment for an octenol lure and is constructed and arranged to dispense the octenol lure.

5. The device of claim 4, wherein the inner housing comprises openings along a bottom portion, the openings constructed and arranged to allow convective air flow to vaporize the octenol lure and dispense the octenol lure.

6. The device of claim 1, further comprising at least one visual lure on the base portion surrounded by the inner housing.

7. The device of claim 6, wherein the at least one visual lure comprises a plurality of purple LEDs that illuminate the inner housing.

8. The device of claim 1, wherein the cleaning element comprises openings exposing the zapper element.

9. The device of claim 1, further comprising ridges on the inner housing extending crosswise to a sliding direction of the cleaning element.

10. The device of claim 9, wherein the ridges comprise protrusions, the electric coils being wrapped around the protrusions.

11. The device of claim 9, further comprising an outer housing having slats spaced apart from each other surrounding the plastic housing and electric coils, wherein the slats are positioned in recesses between the protrusions.

12. The device of claim 1, wherein the cleaning element comprises a removable strap.

13. The device of claim 12, wherein the removable strap is configured to be coupled to the cleaning element in a plurality of configurations.

14. The device of claim 1, wherein the base portion comprises non-slip feet.

15. The device of claim 1, wherein the inner housing comprises light guide transparent plastic.

16. The device of claim 1, wherein the power source is at least one rechargeable battery and the base portion comprises a USB Type-C charging port.

17. The device of claim 1, wherein the base portion comprises a release button that disengages a lock and releasing the cleaning element to enable the movement with respect to the zapper element.

18. The device of claim 1, wherein the cleaning element is configured to slide with respect to the zapper element.

19. The device of claim 1, wherein the base portion comprises at least one control button constructed and arranged to change an operating mode of the device among a plurality of different operating modes.

20. The device of claim 19, wherein the control button changes the operating mode of the device between a first operating mode in which the device is not operating, a second operating mode in which the device is operating with both the electric coils and a visual lure in operation, and a third mode in which the device is operating with only the electric coils in operation.
